(19) United States
(12) Patent Application Publication
(10) Pub. No.: US 2005/0098600 A1
(43) Pub. Date: May 12, 2005

(54) Streamline folded t-shirt style produce bag for roll mounting

(75) Inventors: Ron C. Yeh, Morganville, NJ (US); Ben Tseng, East Brunswick, NJ (US)

Correspondence Address: Kenneth P. Glynn, Esq.;Glynn & Associates, P.C., 24 Mine Street, Flemington, NJ, 08822, US

(73) Assignee: Inteplast Group, Ltd.

(21) Appl. No.: 10/706,553

(22) Filed: Nov. 12, 2003

(51) Int. Cl. B26F 3/00; B26F 3/02

(52) U.S. Cl. 225/93

(57) ABSTRACT

A streamline folded T-shirt style produce bag includes: (a) a front panel, (b) a rear panel (c) two front gusset panels, (d) two rear gusset panels, (e) each front panel also joined to a respective one of the rear gusset panels at the second side edge; (f) each of the front and rear gusset panels being folded inwardly relative to the front and the rear panel; (g) the top edges of the front panel, the rear panel, the front gusset and the rear gusset panels terminating in a first perforation line, (h) an upper seam, said upper seam connecting the front panel, the rear panel, the front gusset panel and the rear gusset panels (i) the bottom edges of the front panel, the rear panel, the front gusset panels and the rear gusset panels terminating in a second perforation line, said second perforation line being perpendicular to the linear edges of the front and rear panels; (j) a lower seam, said lower seam connecting the front panel, the rear panel, the front gusset panels, and the rear gusset panels. The bags are folded inwardly from the first and second linear side edges, to establish a left fold area, a right fold area and a center area, with each of the left fold area, right fold area and center area having predetermined widths, wherein the sum of the left fold area width and the right fold area width is greater then the center area width.

### BACKGROUND OF THE INVENTION

1. Field of the Invention

The present invention relates to plastic bags typically used in supermarkets and other retail stores, especially in produce and similar departments. The present invention bags are folded in a unique manner to increase efficiency, reduce space, reduce waste, reduce user error and decrease dispenser material consumption and space.

2. Information Disclosure Statement

The following prior art is representative of the state of the art in the field of pest control dusting devices:

Roll mounted produce bags are commonly found in modern grocery stores and supermarkets. These bags are designed for customers to use when purchasing fresh produce. The bags currently available are difficult for customers to use for several reasons. First, the bags tend to cling together and are difficult to separate from the roll. Second, it is difficult to tell the open end of the bag from the closed end of the bag. Third, the bags are difficult to open, as the sides tend to cling together. Fourth, the bags do not provide carrying handles. A roll-mounted produce bag that identifies the proper end to open is partially opened by dispensing rack and that provides carrying handles would save time and effort for produce purchasers.

Various designs have been developed for dispensers for roll mounted bags, incorporating a number of different technologies. U.S. Pat. No. 4,179,055 issued to Milner, discloses a device for separating a continuous strip of plastic bags mounted on a roll separated by scores lines. The bags pass between a plate and a pressure bar. A prong projects outwardly from the center portion of the plate to facilitate separation of the bags along the score lines and to display the next bag for easy grasping by an operator.

U.S. Pat. No. 4,714,191 issued to Richardson, describes a one piece paperboard carton blank folded into a rectangular shape for packaging and dispensing from a roll of individual plastic bags, particularly disposable milk bags for feeding babies. The individual bags are connected by perforations. The carton includes a tab protruding in the direction opposite to the direction of withdrawal of bags from the roll. When the center of the perforated edge of the bag is impaled on the tab, further withdrawal of a succeeding bag is restrained and the first bag is readily separated to facilitate its. dispensing while locating the leading edge of the succeeding bag where it may be easily reached for withdrawal.

U.S. Pat. No. 5,558,262 issued to Simhaee, discloses a plastic bag dispenser that holds a continuous roll of bags connected by perforated separation lines. The dispenser is provided with a tongue, which the bags are dispensed over, that engages the separation line between the bag at the end of the roll and the next bag. The roll of bags rests in curved grooves in the dispenser that cause the roll to abut and frictionally engage an interior surface of the dispenser, preventing freewheeling of the roll.

U.S. Pat. No. 5,556,019 issued to Morris, describes a bag separator and dispenser for use with bags wound on a core and separated by perforation lines at each end of the bags. The perforation lines include a slot that is collinear with the perforations and is used to engage a separator projection. The projection enters the slot as the bags are pulled from the roll. The dispenser includes two braking devices to control the removal of bags from the roll, a braking bar underneath the roll of bags and a pair of fingers that are attached to the channel for the core and are designed to engage the care as the number of bags on the roll decreases.

U.S. Pat. No. 5,934,535 issued to Kannankeril, discloses a roll of bags having a core with an indexing member on at least one end. The dispenser comprises a wire frame formed into channels to support the core. The dispenser includes at least one brake attached to a support member and disposed at an angle to the support member to provide tension to the edges of the roll of bags as the core passes through the channel passageway as the bags are removed from the roll. Spaced apart from the support is a separating tongue. The tongue engages the slot regardless of whether the bags are drawn over or under the tongue.

U.S. Pat. No. 6,481,594 issued to Yeh et al describes a roll mounted T-shirt bag and dispensers for same. The bag is designed for fresh produce and includes front and rear panels, first and second side gussets, a bottom seam, a top seam and a-U-shaped cutout forming an openable bag mouth and a pair of carrying handles. The bags are joined above and below the upper and lower seams at first and second perforation lines. The bags are wound onto a cylindrical core to form a compact roll. In a variant of the invention, the bags are folded inwardly from the side edges prior to rolling onto the core to form a more compact roll. Dispensers are described that are designed to hold the roll mounted bags in both folded and unfolded form. The dispensers include a separating tongue designed to engage the U-shaped cutout and permit the bags to be dispensed from the bottom of the bag roll. The dispensers are designed for mounting to either vertical or horizontal surfaces and function efficiently in very limited spaces.

Notwithstanding the prior art, the present invention is neither taught nor rendered obvious thereby.

### SUMMARY OF THE INVENTION

The present invention relates to a streamline folded T-shirt style produce bag for roll mounting and subsequent dispensing at retail locations such as supermarkets and other stores. The present invention bag includes:

(a) a front panel, said front panel having first and second parallel linear side edges, a top and a bottom edge;

(b) a rear panel said rear panel having a second parallel linear side edges, a top and bottom edge and a bottom edge;

(c) two front gusset panels of a first of a first predetermined dimension, each front gusset panel having a top edge, a bottom edge, first and second parallel side edges and being joined at said first edge to one of the linear side edges o of the front panel and extending from top edge of the front panel to the bottom edge thereof;

(d) two rear gusset panels of the first predetermined dimension, each rear gusset panel having a top edge, a bottom edge, first and second parallel side edges and being joined at said first and side edges of the rear panel extending from top edge of the rear panel to the bottom edge thereof;

(e) each front panel also joined to a respective one of said rear gusset panels at said second side edge;

(f) each of the front and rear gusset panels being folded inwardly relative to the front and the rear panel;

(g) the top edges of the front panel, the rear panel, the front gusset and the rear gusset panels terminating in the first perforation line, said first perforation line being perpendicular to the linear side edges of the front and rear panels;

(h) an upper seam, said upper seam connecting the front panel, the rear panel, the front gusset panel and the rear gusset panels at a level spaced downwardly from and parallel to said second perforation line;

(i) the bottom edges of the front panel, the rear panel, the front gusset panels and the rear gusset panels terminating in a second perforation line, said second perforation line being perpendicular to the linear edges of the front and rear panels;

(j) a lower seam, said lower seam connecting the front panel, the rear panel, the front gusset panels, and the rear gusset panels at a level spaced upwardly from and parallel to said perforation line;

wherein said bags are rollable from their upper seams towards their lower seams onto a core from a compact roll from which bags are dispensed; and,

wherein said bags are folded inwardly from the first and second linear side edges, to establish a left fold area, a right fold area and a center area, with each of said left fold area, right fold area and center area having predetermined widths, wherein the sum of the left fold area width and the right fold area width is greater then the center area width.

In some preferred embodiments, the present invention streamline folded T-shirt type produce bag further includes:

(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles; said second perforation line attaching the bag to a subsequent bag.

In another embodiment, the present invention includes a plurality of streamline folded T-shirt type produce bags and bag dispenser, in combination. Here, a plurality of the above-described bags are rolled onto a cylindrical core and mounted onto a dispenser having the following characteristics:

(a) a supported base;

(b) a surrounding upper member, said attachment member being spaced upwardly from said supporting base and sized and shaped to enclose at least a rear portion of a bag rolled;

(c) an attached member, said attached member being fixedly attached to said supporting base and said surrounding upper member and providing means for securing said dispenser to either of a vertical surface and a horizontal surface;.

(d) a first and second parallel, upwardly angled slots, each of said slots having a front edge member and a rear edge member extending upwardly from said supporting base and connecting and extending above said surrounding upper member and being sized, shaped and disposed to slidably constrain first and second ends of a cylindrical produce bag core on which said bags are wound in a roll;

(e) said angled slots permitting said bag core to slide downwardly within said slots;

(f) first and second core supports, said core supports disposed adjacent upper ends of said first and second slots and providing a bearing surface for said produce bag core;

(g) a bag constraining ring, said constraining ring being mounted between said front edge member of said upwardly angled slots being slots sized and shaped to fit frictionally about a bag as it is removed from said bag roll;

(h) upper and lower separating tongues, said upper and lower tongues being affixed to upper and lower portions of said bag constraining ring, respectively and pointing toward an interior of said ring and being sized and shaped to locate the U-shaped cutout in the upper portion of the bags as bags are being pulled from said bag roll; and

(i) whereby, when rolled of T-shirt style bags is mounted in the dispenser with its core resting upon said first and second core supports, the roll may be arranged to dispense from either of the top and the bottom of the bag roll, and when a leading bag from the roll is fed through the constraining ring adjacent either of the upper and lower separating tongues, one of said tongues will serve to engage the U-shaped cutout in the upper portion of the bag and facilitate tearing of the perforation joining said leading bag to a subsequent bag on the roll.

The present invention also includes the method of making a plurality of connected, streamline folded t-shirt style produce bags. The method includes:

(A) making a plurality of bags, connected in series, each of said bags being as follows:
(a) a front panel, said front panel having first and second parallel linear side edges, a top and a bottom edge;

(b) a rear panel said rear panel having a second parallel linear side edges, a top and bottom edge and a bottom edge;
(c) two front gusset panels of a first of a first predetermined dimension, each front gusset panel having a top edge, a bottom edge, first and second parallel side edges and being joined at said first edge to one of the linear side edges o of the front panel and extending from top edge of the front panel to the bottom edge thereof;
(d) two rear gusset panels of the first predetermined dimension, each rear gusset panel having a top edge, a bottom edge, first and second parallel side edges and being joined at said first and side edges of the rear panel extending from top edge of the rear panel to the bottom edge thereof;
(e) each front panel also joined to a respective one of said rear gusset panels at said second side edge;
(f) each of the front and rear gusset panels being folded inwardly relative to the front and the rear panel;
(g) the top edges of the front panel, the rear panel, the front gusset and the rear gusset panels terminating in the first perforation line, said first perforation line being perpendicular to the linear side edges of the front and rear panels;
(h) an upper seam, said upper seam connecting the front panel, the rear panel, the front gusset panel and the rear gusset panels at a level spaced downwardly from and parallel to said second perforation line;
(i) the bottom edges of the front panel, the rear panel, the front gusset panels and the rear gusset panels terminating in a second perforation line, said second perforation line being perpendicular to the linear edges of the front and rear panels;
(j) a lower seam, said lower seam connecting the front panel, the rear panel, the front gusset panels, and the rear gusset panels at a level spaced upwardly from and parallel to said perforation line; said second perforation line attaching the bag to a subsequent bag; and,

(B) folding said bags inwardly from the first and second linear side edges, to establish a left fold area, a right fold area and a center area, with each of said left fold area, right fold area and center area having predetermined widths, wherein the sum of the left fold area width and the right fold area width is greater then the center area width; and,

(C) rolling said bags from their upper seams towards their lower seams onto a core from a compact roll from which bags are dispensed.

In preferred embodiments, the present invention method of making a plurality of connected, streamline folded t-shirt style produce bags includes the step wherein each of said bags is made to further include:

(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles.

### BRIEF DESCRIPTION OF THE DRAWINGS

The present invention should be more fully understood when the specification herein is taken in conjunction with the drawings appended hereto wherein:

FIG. 1 is a perspective view of the preferred embodiment of the T-shirt style bag of the present invention illustrating a pair of side gussets, upper and lower seams and an openable mouth;

FIG. 2 is a cross sectional view of the FIG. 1 bag;

FIG. 3 is a perspective view of the FIG. 1 bag folded inwardly from the parallel side edges in an overlapping fold, as shown;

FIG. 4 is a perspective view of a plurality of the FIG. 1 bags folded inwardly from the parallel side edges and rolled onto a cylindrical core suitable for a dispenser;

FIG. 5 is a cross-sectional view of the present invention bag shown in FIG. 3, folded; and,

FIG. 6 through 8 show a bag roll dispenser incorporated into some embodiments of the present invention.

### DETAILED DESCRIPTION OF THE PRESENT INVENTION

The prior art produce bags have a number of disadvantages that are overcome by the present invention. For example, the width of the dispensers are sometimes too wide for their store locations, creating traffic slow ups or awkward maneuvers for shoppers. Additionally, because the folds of the prior art bags leave an opening for shoppers to grab at the top center, sometimes the bags are ripped apart as when a shopper catches only half (front) of the bag. Likewise, some waste occurs because the bags are accidentally destroyed when the shopper pulls on the opening instead of the bottom of the bag. The present invention bags, on the other hand, have no exposed top opening when folded and eliminate the foregoing. The present invention bags also take up less space in shipping and the dispenser uses less space and consumes less metal in its fabrication.

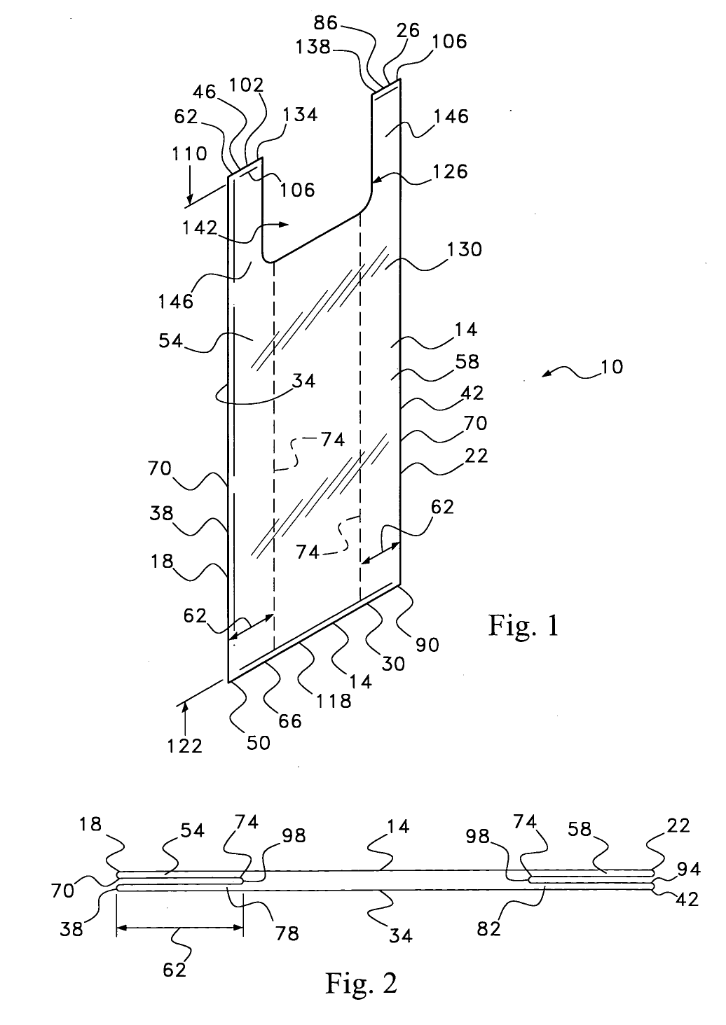

FIGS. 1, 2, 3, 4 and 5 illustrate a present invention T-shirt type plastic produce bag 10 providing the desired features of the present invention that may be constructed from the following components. These Figures are discussed collectively, and, to the extent that identical numbers are used, they describe identical elements. A front panel 14 has first 18 and second 22 parallel linear side edges, a top edge 26 and a bottom edge 30. A rear panel 34 has first 38 and second 42 parallel linear side edges, a top edge 46 and a bottom edge 50. Two front gusset panels 54, 58 of a first predetermined dimension width 62 are provided. Each front gusset panel 54, 58 has a top edge 62, bottom edge 66, first 70 and second 74 parallel side edges. The front gusset panels 54, 58 are connected at the first side edge 70 to one of the linear side edges 18, 22 of the front panel 14 and extend from the top edge 26 to the bottom edge 30 of the front panel.

Two rear gusset panels 78, 82 of the first predetermined dimension width 62 are provided. Each rear gusset panel 78, 82 has a top edge 86, a bottom edge 90, first 94 and second 98 parallel side edges. The rear gusset panels 78, 82 are connected at the first side edge 94 to one of the linear side edges 38, 42 of the rear panel 34 and extend from the top edge 46 to the bottom edge 50 of the rear panel 34. Each front gusset panel 54, 58 is also connected to a respective one of the rear gusset panels 78, 82 at the second side edge 98. Each of the front 54, 58 and rear gusset panels 78, 82 is folded inwardly relative to the front 14 and the rear panel 34.

The top edges 26, 46, 62, 86 of the front panel 14, the rear panel 34, the front gusset panels 54, 58 and the rear gusset panels 78, 82 terminate in a first perforation line 102. The first perforation line 102 is perpendicular to the linear side edges 18, 22, 38, 42 of the front 14 and rear 34 panels. An upper seam 106 connects the front panel 14, the rear panel 34, the front gusset panels 54, 58 and the rear gusset panels 78, 82 at a level 110 spaced downwardly from and parallel to the first perforation line 102. The bottom edges 30, 50, 66, 90 of the front panel 14, the rear panel 34, the front gusset panels 54, 58 and the rear gusset panels 78, 82 terminate in a second perforation line 114. The second perforation line 114 is perpendicular to the linear side edges 18, 22, 38, 42 of the front 14 and rear 34 panels. A lower seam 118 connects the front panel 14, the rear panel 34, the front gusset panels 54, 58 and the rear gusset panels 78, 82 at a level 122 spaced upwardly from and parallel to the second perforation line 114.

An optional, but preferred U-shaped cutout 126 is located in an upper portion 130 of the bag 10. The U-shaped cutout 126 begins at first point 134 along the first perforation line 102. The first point 134 is spaced inwardly from the first linear side edge 18, 38 and extends to a second point 138 along the first perforation line 102. The second point 138 is spaced inwardly from the second linear side edge 22, 42. The cutout 126 extends downwardly toward the lower seam 118, forming an open mouth 142 and a pair of bag handles 146. The second perforation line 114 attaches the bag 10 to a subsequent bag 10. The bags 10 could be rolled from their upper seams 106 toward their lower seams 118 onto a cylindrical core 148 to form a compact roll 150 from which the bags 10 are dispensed. Alternatively, they could be folded in accordance with U.S. Pat. No. 6,481,594 B1 cited above. However, they difficulties cited above in the first paragraph of this section could occur, and this is eliminated in the present invention by the unique folding, as now will be described

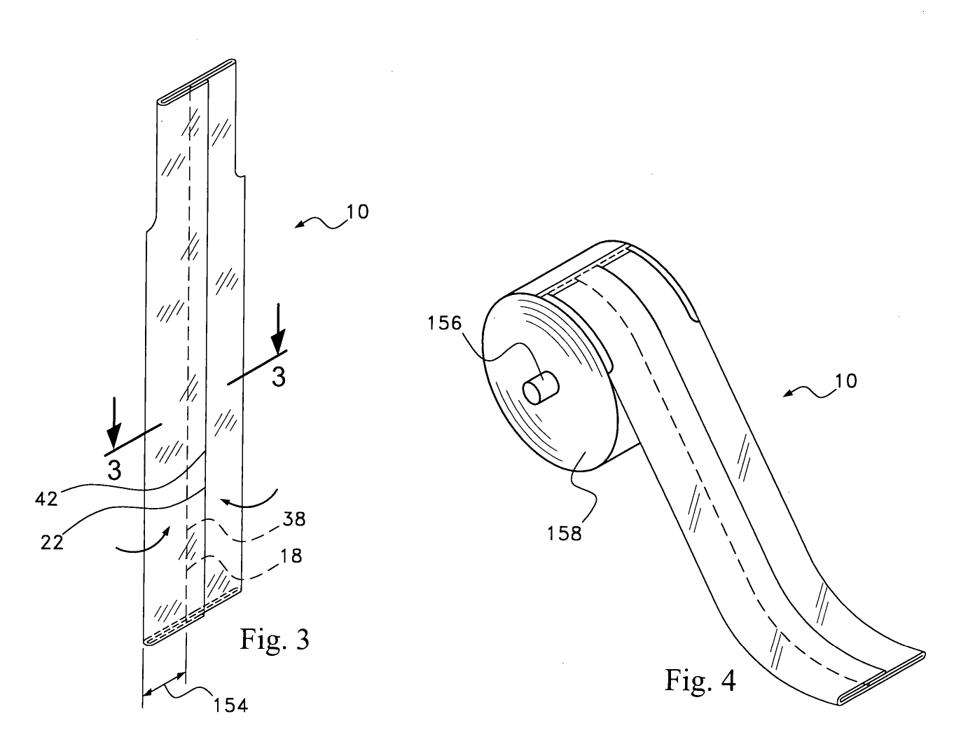

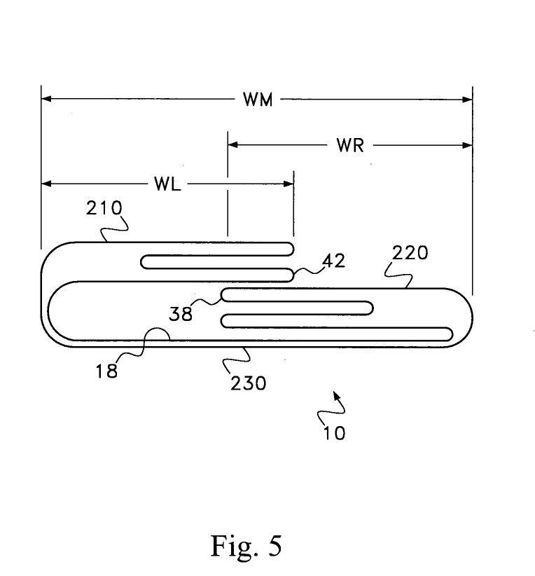

In a critical aspect of the present invention, as illustrated in FIGS. 3, 4 and 5, the bag 10 is folded inwardly from the first 18, 38 and second 22, 42 linear side edges for a third predetermined dimension 154 prior to rolling the bags 10 onto a cylindrical core 156, thereby providing a more compact roll 158 of bags 10. Thus, especially vividly illustrated in FIG. 5, a left fold area 210 and a right fold area 220 are established by the above-described folding steps. The bag is folded inwardly from the first and second linear side edges, to establish the left fold area 210, the right fold area 220 and a center area 230, with each of said left fold area 210, right fold area 220 and center area 230, having predetermined widths, WL, WR and WM, respectively, wherein the sum of the left fold area width WL and the right fold area width WR is greater then the center area width WM, as shown.

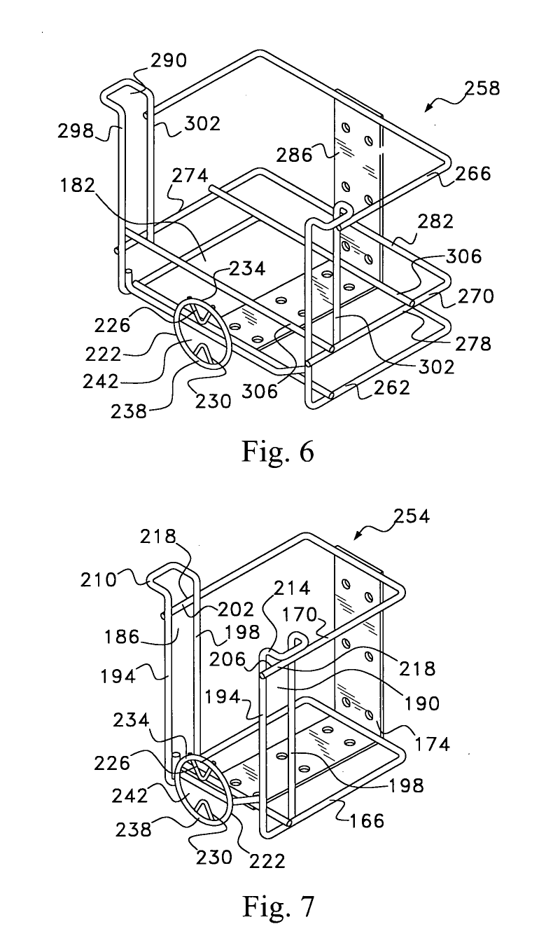

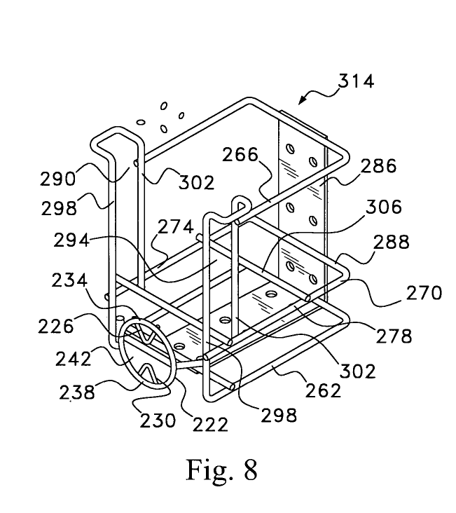

FIGS. 6 through 8 show bag roll dispensers 258, 254 and 314 respectively, that are used as described above and otherwise incorporated into some embodiments of the present invention. Detalied description is set forth in detail in U.S. Pat. No. 6,481,594 B1 issued on Nov. 19, 2003 and incorporated herein in its entirety.

Obviously, numerous modifications and variations of the present invention are possible in light of the above teachings. It is therefore understood that within the scope of the appended claims, the invention may be practiced otherwise than as specifically described herein.

1. A streamline folded T-shirt style produce bag for roll mounting, which comprises:
(a) a front panel, said front panel having first and second parallel linear side edges, a top and a bottom edge;
(b) a rear panel said rear panel having a second parallel linear side edges, a top and bottom edge and a bottom edge;
(c) two front gusset panels of a first of a first predetermined dimension, each front gusset panel having a top edge, a bottom edge, first and second parallel side edges and being joined at said first edge to one of the linear side edges o of the front panel and extending from top edge of the front panel to the bottom edge thereof;
(d) two rear gusset panels of the first predetermined dimension, each rear gusset panel having a top edge, a bottom edge, first and second parallel side edges and being joined at said first and side edges of the rear panel extending from top edge of the rear panel to the bottom edge thereof;
(e) each front panel also joined to a respective one of said rear gusset panels at said second side edge;
(f) each of the front and rear gusset panels being folded inwardly relative to the front and the rear panel;
(g) the top edges of the front panel, the rear panel, the front gusset and the rear gusset panels terminating in the first perforation line, said first perforation line being perpendicular to the linear side edges of the front and rear panels;
(h) an upper seam, said upper seam connecting the front panel, the rear panel, the front gusset panel and the rear gusset panels at a level spaced downwardly from and parallel to said second perforation line;
(i) the bottom edges of the front panel, the rear panel, the front gusset panels and the rear gusset panels terminating in a second perforation line, said second perforation line being perpendicular to the linear edges of the front and rear panels;
(j) a lower seam, said lower seam connecting the front panel, the rear panel, the front gusset panels, and the rear gusset panels at a level spaced upwardly from and parallel to said perforation line;
wherein said bags are rollable from their upper seams towards their lower seams onto a core from a compact roll from which bags are dispensed; and,
wherein said bags are folded inwardly from the first and second linear side edges, to establish a left fold area, a right fold area and a center area, with each of said left fold area, right fold area and center area having predetermined widths, wherein the sum of the left fold area width and the right fold area width is greater then the center area width.

2. The streamline folded T-shirt style produce bag for roll mounting of claim 1 wherein the bag is folded inwardly from the first and second linear side edges for a third predetermined dimension prior to rolling the bags onto a cylindrical core, thereby providing a more compact roll of bags.

3. The streamline folded T-shirt type produce bag as described in claim 1, wherein said bag further includes:
(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles; said second perforation line attaching the bag to a subsequent bag.

4. A plurality of streamline folded T-shirt type produce bags and bag dispenser, in combination, which comprises:
(A) a plurality of connected streamline folded T-shirt type produce bags, each of said bags including:
a) a front panel, said front panel having first and second parallel linear side edges, a top and a bottom edge;
(b) a rear panel said rear panel having a second parallel linear side edges, a top and bottom edge and a bottom edge;
(c) two front gusset panels of a first of a first predetermined dimension, each front gusset panel having a top edge, a bottom edge, first and second parallel side edges and being joined at said first edge to one of the linear side edges o of the front panel and extending from top edge of the front panel to the bottom edge thereof;
(d) two rear gusset panels of the first predetermined dimension, each rear gusset panel having a top edge, a bottom edge, first and second parallel side edges and being joined at said first and side edges of the rear panel extending from top edge of the rear panel to the bottom edge thereof;
(e) each front panel also joined to a respective one of said rear gusset panels at said second side edge;
(f) each of the front and rear gusset panels being folded inwardly relative to the front and the rear panel;
(g) the top edges of the front panel, the rear panel, the front gusset and the rear gusset panels terminating in the first perforation line, said first perforation line being perpendicular to the linear side edges of the front and rear panels;
(h) an upper seam, said upper seam connecting the front panel, the rear panel, the front gusset panel and the rear gusset panels at a level spaced downwardly from and parallel to said second perforation line;
(i) the bottom edges of the front panel, the rear panel, the front gusset panels and the rear gusset panels terminating in a second perforation line, said second perforation line being perpendicular to the linear edges of the front and rear panels;
(j) a lower seam, said lower seam connecting the front panel, the rear panel, the front gusset panels, and the rear gusset panels at a level spaced upwardly from and parallel to said perforation line;
wherein said bags are rollable from their upper seams towards their lower seams onto a core from a compact roll from which bags are dispensed; and,
wherein said bags are folded inwardly from the first and second linear side edges, to establish a left fold area, a right fold area and a center area, with each of said left fold area, right fold area and center area having predetermined widths, wherein the sum of the left fold area width and the right fold area width is greater then the center area width.
(B) a cylindrical core onto which said plurality of bags are rolled; and,
(C) a bag dispenser having said bags and cylindrical core mounted thereto, said bag dispenser including:
(a) a supported base;
(b) a surrounding upper member, said attachment member being spaced upwardly from said supporting base and sized and shaped to enclose at least a rear portion of a bag rolled;
(c) an attached member, said attached member being fixedly attached to said supporting base and said surrounding upper member and providing means for securing said dispenser to either of a vertical surface and a horizontal surface;
(d) a first and second parallel, upwardly angled slots, each of said slots having a front edge member and a rear edge member extending upwardly from said supporting base and connecting and extending above said surrounding upper member and being sized, shaped and disposed to slidably constrain first and second ends of a cylindrical produce bag core on which said bags are wound in a roll;
(e) said angled slots permitting said bag core to slide downwardly within said slots;
(f) first and second core supports, said core supports disposed adjacent upper ends of said first and second slots and providing a bearing surface for said produce bag core;
(g) a bag constraining ring, said constraining ring being mounted between said front edge member of said upwardly angled slots being slots sized and shaped to fit frictionally about a bag as it is removed from said bag roll;
(h) upper and lower separating tongues, said upper and lower tongues being affixed to upper and lower portions of said bag constraining ring, respectively and pointing toward an interior of said ring and being sized and shaped to locate the U-shaped cutout in the upper portion of the bags as bags are being pulled from said bag roll; and
(i) whereby, when rolled of T-shirt style bags is mounted in the dispenser with its core resting upon said first and second core supports, the roll may be arranged to dispense from either of the top and the bottom of the bag roll, and when a leading bag from the roll is fed through the constraining ring adjacent either of the upper and lower separating tongues, one of said tongues will serve to engage the U-shaped cutout in the upper portion of the bag and facilitate tearing of the perforation joining said leading bag to a subsequent bag on the roll.

5. The plurality of streamline folded T-shirt type produce bags and bag dispenser, in combination, wherein each of said bags further incudes:
(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles; said second perforation line attaching the bag to a subsequent bag.

6. A method of making a plurality of connected, streamline folded t-shirt style produce bags, which comprises:
(A) making a plurality of bags, connected in series, each of said bags being as follows:
(a) a front panel, said front panel having first and second parallel linear side edges, a top and a bottom edge;
(b) a rear panel said rear panel having a second parallel linear side edges, a top and bottom edge and a bottom edge;
(c) two front gusset panels of a first of a first predetermined dimension, each front gusset panel having a top edge, a bottom edge, first and second parallel side edges and being joined at said first edge to one of the linear side edges o of the front panel and extending from top edge of the front panel to the bottom edge thereof;
(d) two rear gusset panels of the first predetermined dimension, each rear gusset panel having a top edge, a bottom edge, first and second parallel side edges and being joined at said first and side edges of the rear panel extending from top edge of the rear panel to the bottom edge thereof;
(e) each front panel also joined to a respective one of said rear gusset panels at said second side edge;
(f) each of the front and rear gusset panels being folded inwardly relative to the front and the rear panel;
(g) the top edges of the front panel, the rear panel, the front gusset and the rear gusset panels terminating in the first perforation line, said first perforation line being perpendicular to the linear side edges of the front and rear panels;
(h) an upper seam, said upper seam connecting the front panel, the rear panel, the front gusset panel and the rear gusset panels at a level spaced downwardly from and parallel to said second perforation line;
(i) the bottom edges of the front panel, the rear panel, the front gusset panels and the rear gusset panels terminating in a second perforation line, said second perforation line being perpendicular to the linear edges of the front and rear panels;
(j) a lower seam, said lower seam connecting the front panel, the rear panel, the front gusset panels, and the rear gusset panels at a level spaced upwardly from and parallel to said perforation line; said second perforation line attaching the bag to a subsequent bag; and,
(B) folding said bags inwardly from the first and second linear side edges, to establish a left fold area, a right fold area and a center area, with each of said left fold area, right fold area and center area having predetermined widths, wherein the sum of the left fold area width and the right fold area width is greater then the center area width; and,
(C) rolling said bags from their upper seams towards their lower seams onto a core from a compact roll from which bags are dispensed.

7. The method of making a plurality of connected, streamline folded t-shirt style produce bags of claim 6, wherein the bag is folded inwardly from the first and second linear side edges for a third predetermined dimension prior to rolling the bags onto a cylindrical core, thereby providing a more compact roll of bags.

8. The method of making a plurality of connected, streamline folded t-shirt style produce bags of claim 6, wherein each of said bags further is made to include:
(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles.

9. The method of making a plurality of connected, streamline folded t-shirt style produce bags of claim 6, which further includes mounting said core with said bags that have been rolled thereon, onto a roll—receiving, bag dispenser, said bag dispenser including:
(a) a supported base;
(b) a surrounding upper member, said attachment member being spaced upwardly from said supporting base and sized and shaped to enclose at least a rear portion of a bag rolled;
(c) an attached member, said attached member being fixedly attached to said supporting base and said surrounding upper member and providing means for securing said dispenser to either of a vertical surface and a horizontal surface;
(d) a first and second parallel, upwardly angled slots, each of said slots having a front edge member and a rear edge member extending upwardly from said supporting base and connecting and extending above said surrounding upper member and being sized, shaped and disposed to slidably constrain first and second ends of a cylindrical produce bag core on which said bags are wound in a roll;
(e) said angled slots permitting said bag core to slide downwardly within said slots;
(f) first and second core supports, said core supports disposed adjacent upper ends of said first and second slots and providing a bearing surface for said produce bag core;
(g) a bag constraining ring, said constraining ring being mounted between said front edge member of said upwardly angled slots being slots sized and shaped to fit frictionally about a bag as it is removed from said bag roll;
(h) upper and lower separating tongues, said upper and lower tongues being affixed to upper and lower portions of said bag constraining ring, respectively and pointing toward an interior of said ring and being sized and shaped to locate the U-shaped cutout in the upper portion of the bags as bags are being pulled from said bag roll; and
(i) whereby, when said roll of T-shirt style bags is mounted in the dispenser with its core resting upon said first and second core supports, the roll may be arranged to dispense from either of the top and the bottom of the bag roll, and when a leading bag from the roll is fed through the constraining ring adjacent either of the upper and lower separating tongues, one of said tongues will serve to engage the U-shaped cutout in the upper portion of the bag and facilitate tearing of the perforation joining said leading bag to a subsequent bag on the roll.

10. The method of making a plurality of connected, streamline folded t-shirt style produce bags of claim 6, wherein each of said bags further is made to include:
(k) A U-shaped cutout, said U-shaped cutout being disposed in an upper portion of the bag commencing at a first in an upper point along the first perforation line spaced inwardly front said first linear side edge and extending to a second point along first perforation line spaced inwardly front said second linear side edge, said cutout extending downwardly toward the lower seam, thereby forming an open mouth and a pair of bag handles.
